(19) United States
(12) Patent Application Publication
(10) Pub. No.: US 2026/0072666 A1
(43) Pub. Date: Mar. 12, 2026

(54) NETWORK DEVICE, CONTROL METHOD FOR NETWORK DEVICE, AND STORAGE MEDIUM

(71) Applicant: CANON KABUSHIKI KAISHA, Tokyo (JP)

(72) Inventor: HIROFUMI TSURUTA, Kanagawa (JP)

(21) Appl. No.: 19/297,219

(22) Filed: Aug. 12, 2025

(30) Foreign Application Priority Data
Sep. 6, 2024 (JP) 2024-154009

(51) Int. Cl. G06F 8/61; H04L 67/02

(52) U.S. Cl. CPC G06F 8/61; H04L 67/02

(57) ABSTRACT

A network device having a webserver includes a display, at least one memory storing instructions, and at least one processor executing the stored instructions causing the network device to display, on the display, code information for accessing a website on a web browser, the website being provided by the webserver in order to install software as a progressive web app for providing at least a portion of functions of the network device on a user terminal.

### BACKGROUND

### FIELD OF THE TECHNOLOGY

The present disclosure relates to a network device, a control method for a network device, and a storage medium.

### DESCRIPTION OF THE RELATED ART

Progressive Web Apps (referred to below as PWAs) are conventionally known. A user installs a PWA on a user terminal by, for example, operating the user terminal, and then uses the PWA on the user terminal. In addition, a technology for reducing the labor of the user associated with the use of downloaded software is also known. Japanese Unexamined Patent Application, First Publication No. 2022-21274 discloses that a user terminal transmits a browsing request for a webpage with a specified URL along with user identifying information that has been written on an application installation page to an information provision system, acquires a provisional registration page from the information provision system, and performs user registration.

In this context, in a case in which the user installs the PWA on a user terminal by operating the user terminal, it is desirable that the installation be easily performable. On this point, conventionally, the user accesses a website used in the installation of the PWA on the user terminal by inputting address information for the website into the user terminal, and installs the PW on the user terminal on the website. In this case, the labor of the user inputting the address information into the user terminal occurs. In addition, in a case in which there is an error in the address information that the user has input into the user terminal, the user terminal will not connect to the website, and the PWA will not be installed. In this manner, the installation of a PWA on a user terminal is cumbersome.

### SUMMARY

The present disclosure is directed to provide a network device that allows a user to easily execute installation of a progressive web app for providing at least a portion of functions of the network device onto a user terminal in a situation in which the user is able to operate the network device.

According to an aspect of the present disclosure, a network device having a webserver includes a display, at least one memory storing instructions, and at least one processor executing the stored instructions causing the network device to display, on the display, code information for accessing on a web browser a website that is provided by the webserver for installing software as a progressive web app for providing at least a portion of functions of the network device on a user terminal.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram of an overall configuration of a function provision system.

FIG. 2A is a diagram showing a hardware configuration for an information terminal, and FIG. 2B is a diagram showing a hardware configuration for a multifunction peripheral.

FIG. 3A is a diagram showing a functional configuration of a multifunction peripheral, and FIG. 3B is a diagram showing a functional configuration of an information terminal.

FIG. 4 is a diagram showing information that is stored in a user management database.

FIG. 5 is a diagram showing a setting screen.

FIG. 6 is a flowchart showing a generation processing flow.

FIG. 7 is a flowchart showing a display processing flow.

FIG. 8A is a diagram showing a prompt screen, and FIG. 8B is a diagram showing an installation screen.

FIG. 9A is a diagram showing an authentication screen, and FIG. 9B is a diagram showing a provision screen.

FIG. 10 is a diagram showing a notification image.

FIG. 11 is a flowchart showing a provision processing flow.

FIG. 12 is a flowchart showing an update processing flow.

### DESCRIPTION OF THE EMBODIMENTS

Below, embodiments of the present disclosure will be explained with reference to the figures.

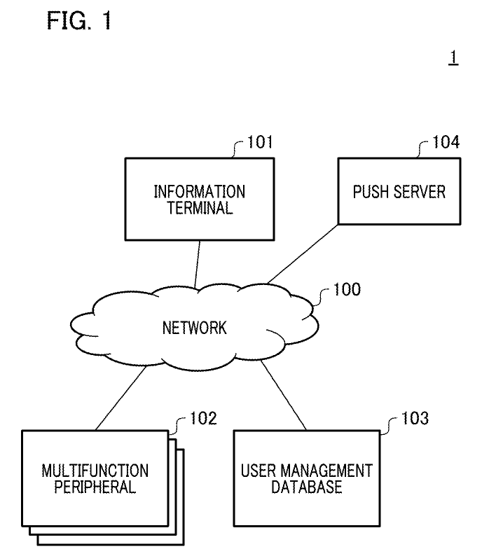

FIG. 1 is a diagram of an overall configurational of a function provision system 1. The function provision system 1 is a system that provides at least a portion of the functions of a network device, which is a device that is able to perform telecommunications, to a terminal of a user that is accessing (connected to) the network device. Note that an image processing apparatus such as a multifunction peripheral (MFP) and the like is given as an example of the network device. However, the device may be a device that is different from an image processing apparatus such as, for example, a network router, a surveillance camera, a digital medical device, and the like.

The function provision system 1 is provided with an information terminal 101, a multifunction peripheral 102, a user management database 103, and a push server 104. The information terminal 101, the multifunction peripheral 102, the user management database 103, and the push server 104 are connected via a network 100.

The multifunctional peripheral 102, which is one example of a network device, has functions such as printing, faxing, copying, scanning, data transmission, and the like. The multifunction peripheral 102 of the present embodiment provides at least a portion of its functions to the information terminal 101. Examples are given of the functions of the multifunctional peripheral 102 that are provided to the information terminal 101 from the multifunctional peripheral 102 of, for example, notifications of the state of the multifunction peripheral 102, job commands for the multifunction peripheral 102, settings for the multifunction peripheral and the like. The functions that are provided to the information terminal 101 from the multifunction peripheral 102 can also be perceived as a remote user interface (remote UI)

In addition, the multifunction peripheral 102 of the present embodiment provides at least a portion of the functions of the multifunction peripheral 102 to the information terminal 101 by installing a progressive web app (PWA) on the information terminal 101. PWAs are a technology that makes it possible for a web application associated with a website to be immediately used as an application that operates on the information terminal 101. The PWA is an application software that is constructed by using a general web technology such as HTML, CSS, Java Script, Web Assembly, and the like, and that can be downloaded and installed via a web browser.

In addition, the PWA does not require a download operation by a user from, for example, an app store that is developed by a vendor that provides an operating system (OS). The user is able to use the PWA by connecting the information terminal 101 to the website that is used to install the PWA, and installing the PWA on the information terminal 101 on the website to which it has been connected. In addition, the contents of the PWA are freely designed by the provider of the website. Note that below, the website that is used to install the PWA will be referred to as the installation website.

In addition, in the PWA, it is also possible to realize push notifications to the client device, the display of icons on a home screen of the client device, and the like from the application server that is constructed by the provision source for the website, and the like using a server worker function. These push notifications are realized via the push server 104. In addition, a specific API that is supported by the OS and the browser of the information terminal 101 is used for the push notifications.

In addition, the multifunction peripheral 102 of the present embodiment installs the PWA on the information terminal 101 without requiring an input operation for address information for the installation website to the information terminal 101 from the user. More specifically, the multifunction peripheral 102 connects the information terminal 101 to the installation site by having the information terminal 101 read information comprising address information for the installation site.

Note that although in the examples shown in the figures, three multifunction peripherals are provided to the information provision system 1, the present disclosure is not limited thereto. The number of network devices provided to the function provision system 1 may be any number as long as this number is one or more.

The information terminal 101, which is one example of a user terminal, is a terminal apparatus that is used by the user of the function provision system 1. The user understands the state of the multifunction peripheral 102, and sends job commands to the multifunction peripheral 102 by using the information terminal 101 on which the PWA has been installed. An example is given of the information terminal 101 of, for example, a computer apparatus such as a PC, a smartphone, a tablet terminal, and the like.

The user management database 103 manages user information by storing information relating to users. Note that the information that is stored on the user management database 103 will be explained in detail below.

The push server 104 realizes the push notifications that have been explained above by acquiring information that has been transmitted from the multifunction peripheral 102 and transmitting this to the information terminal 101.

The type of network for the network 100 is not particularly limited as long as it is able to send and receive data, and may also be, for example, the internet, a LAN (local area network), a WAN (wide area network), and the like. In addition, the communication line that is used in the transmission and reception of data may be wired, or it may also be wireless. In addition, the network 100 to which the information terminal 101 and the multifunction peripheral 102 connect and the network 100 to which the multifunction peripheral 102 and the user management database 103 connect may be the same network, or they may also be different networks.

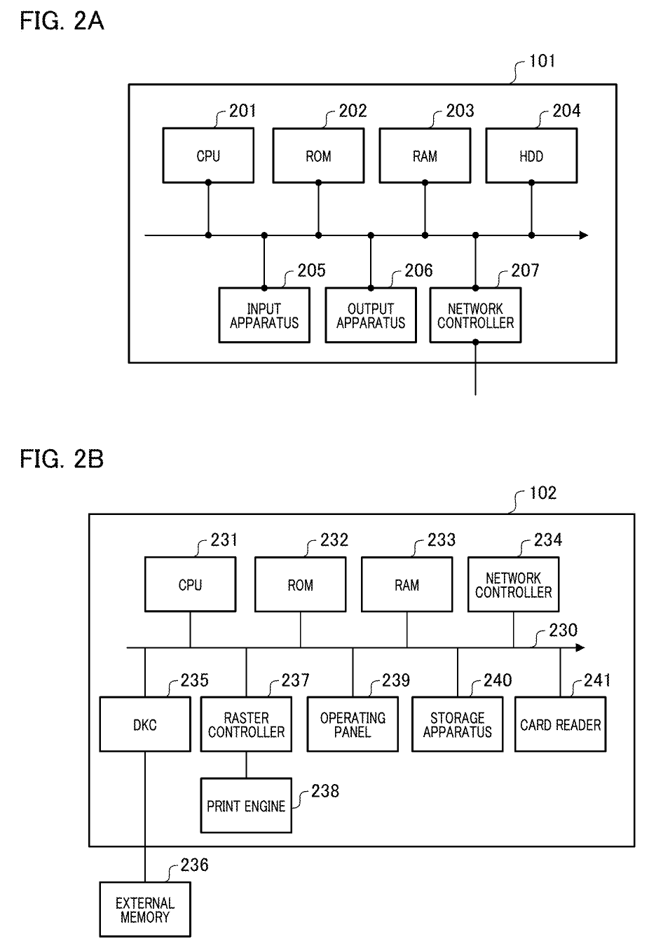

FIG. 2A is a diagram showing a hardware configuration of the information terminal 101. The information terminal 101 has a CPU 201, a ROM 202, a RAM 203, an HDD 204, an input apparatus 205, an output apparatus 206, and an NC (network controller) 207.

The CPU 201 controls the entirety of the information terminal 101. The ROM 202 stores a BIOS. The RAM 203 is a direct storage device that is used as a working region for the CPU 201, and is used as temporary storage for loading a software module. The HDD 204 is an indirect storage device that stores an OS, and software modules, which are both basic software. Note that an indirect storage device such as an SSD (solid state drive) or the like may also be used instead of the HDD 204. The input apparatus 205 is an apparatus that is used to input information into the information terminal 101. An example is given of a keyboard, a pointing device, a microphone, and the like as the input apparatus 205. In addition, in the present embodiment, a camera that reads information such as images and the like is provided as the input apparatus 205. The output apparatus 206 is an apparatus that outputs information such as a display, speakers, and the like. The NC 207 is an interface for connecting to the network 100.

In the information terminal 101, the CPU 201 executes a BIOS, and loads the OS onto the RAM 203 from the HD204 so as to be executable. The CPU 201 loads each type of software module to be described below onto the RAM 203 from the HDD 204 so as to be executable at any time according to the operations of the OS. Each type of software module is operated by being executed by the CPU 201.

FIG. 2B is a diagram showing a hardware configuration for the multifunction peripheral 102. The multifunction peripheral 102 has a CPU 231, a ROM 232, a RAM 233, an NC 234, a DKC (disk controller) 235, a raster controller 237, a print engine 238, an operations panel 239, a storage apparatus 240, and a card reader 241. The CPU 231, the ROM 232, the storage apparatus 240, the NC 234, the DKC 235, the raster controller 237, the operations panel 239, the storage apparatus 240, and the card reader 241 are all connected via a bus 230.

The CPU 231 controls the entirety of a multifunction peripheral 102. This control is based on a control program that has been stored on the ROM 232, a control program and resource data (resource information) that have been stored on an external memory 236 that is connected via the DKC 235, and the like. The RAM 233 functions as a primary memory, and a working region of the CPU 231, and the like, and is configured so as to expand the memory volume using an optional RAM that is connected to an EDF extension port (not shown). The storage apparatus 240 is an external storage unit that functions as a mass memory. The operations panel 239 displays a screen and also receives operation commands from the user via the screen. In addition, the screen that is displayed as the operations panel 239 also includes a screen that receives selections of an operating mode and the like for the multifunction peripheral 102, a screen that displays a state of the multifunction peripheral 102, a screen for receiving selections of data that is a target for printing, and the like. The NC 234 is, for example, a network interface card (NIC), and communicates with an external apparatus. The raster controller 237 is a controller that converts print data that has been stored using for example, a PDL language, into image data. The print engine 238 uses a well-known printing technology to form images on sheets based on image data that is input from the raster controller 237. For example, an electrophotographic method, an inkjet method, a dye sublimation (heat transfer method) method and the like are given as examples of the format that is used in image formation by the multifunction peripheral 102. The card reader 241 reads an IC card on which information that identifies the user has been stored.

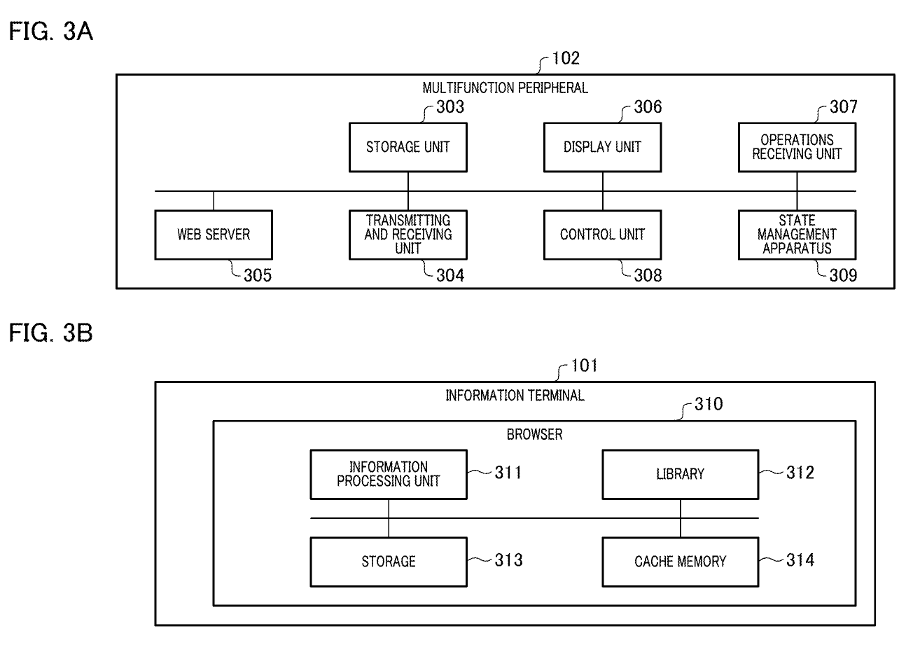

FIG. 3A is a diagram showing a functional configuration of the multifunction peripheral 102. The multifunction peripheral 102 has a storage unit 303, a transmitting and receiving unit 304, a webserver 305, a display unit 306, an operation receiving unit 307, a control unit 308, and a state management unit 309.

The storage unit 303 stores information that has been acquired from the multifunction peripheral 102, and information that has been generated in the multifunction peripheral 102. Information necessary for the management of the multifunction peripheral 102, and the like, is given as an example of the information that is stored in the storage unit 303. For example, firmware information, device configurational information such as an identification number for the multifunction peripheral 102, and the like, each type of counter information, consumption information for consumable products, an operation history for the multifunction peripheral 102, history information showing abnormal states in the multifunction peripheral 102, and the like are given as examples of information that is necessary for the management of the multifunction peripheral 102.

The transmitting and receiving unit 304 transmits and receives information to and from an external device such as the information terminal 101, and the like. The transmission and reception of information by the transmitting and receiving unit 304 uses a protocol such as SMTP, HTTP/HTTPS, SMNP, FTP, SMB, and the like.

The webserver 305 is a module that is used by the multifunction peripheral in order to provide a remote UI.

The display unit 306, which is one example of a display unit, displays information.

The operation receiving unit 307 receives operations by the user for the multifunction peripheral 102.

The state management unit 309 manages the state of the multifunction peripheral 102 by acquiring information showing the state of the multifunction peripheral 102 that has been detected by a sensor that is not shown from the sensor and storing this on the storage unit 303. A state of the presence or absence of abnormalities per function of the multifunction peripheral, a state of the amount of a consumption for each product such as a toner cartridge, a fixing apparatus, and the like in the multifunction peripheral 102, a state of the number of sheets sprinted, and the like, are given as examples of states of the multifunction peripheral 102 that are managed by the state management unit 309.

The control unit 308, which is one example of a control unit, performs control by installing the PWA on the information terminal 101. More specifically, the control unit 308 displays code information in which the address information for the installation site has been encoded on the display unit 306. For example, a QR code (registered trademark), and the like is given as an example of the code information.

In addition, the control unit 308 also functions as a web application server that has been installed on the multifunction peripheral 102. The control unit 308 notifies the information terminal 101 on which the PWA has been installed about the state of the multifunction peripheral 102 that is managed by the state management unit 309, and information showing changes to this state via the push server 104. Information that is stored on the storage unit 303, information showing the state that is managed by the state management unit 309, and the like are given as examples of targets for information notifications by the control unit 308.

In addition, upon receiving a job execution command for the multifunction peripheral 102 from the information terminal 101 via the transmitting and receiving unit 304, the control unit 308 has the multifunction peripheral 102 execute the job that has been received.

Each type of processing by the transmitting and receiving unit 304, the webserver 305, the control unit 308,and the state management unit 309 is realized by the CPU 231 loading and executing a program that has been stored on the ROM 232 and the storage apparatus 240 onto the RAM 233. In addition, the display unit 306 and the operation receiving unit 307 are realized by the operations panel 239. In addition, the storage unit 303 is realized by the ROM 232, and the storage apparatus 240.

FIG. 3B is a diagram showing a functional configuration of the information terminal 101. The information terminal 101 has a browser 310, which is software that is used for browsing a website such as the installation website and the like. The browser 310, which is one example of a web browser, communicates with the webserver 305 of the multifunction peripheral 102. The browser 310 has an information processing unit 311, a library 312, a storage 313, and a cache memory 314.

The information processing unit 311 receives and interprets data in an HTML format. The library 312 performs computational operations. In addition, the library 312 acquires information from external apparatuses, uses library resources, and performs operations. The storage 313 is a non-volatile memory for browser management such as a local storage and the like. Local storage is a memory region that is managed by the browser 310, and is a permanent memory that is able to perform storage independently for each web application. For example, local storage, indexed DB, and the like are given as examples of local storage. The cache memory 314 is a cache memory for increasing the speed of the display when the HTML page that has been read is re-accessed.

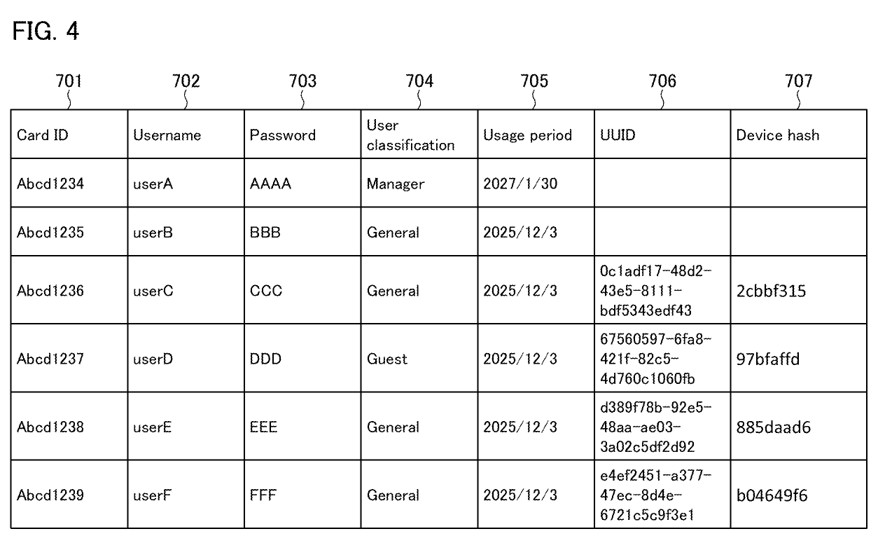

FIG. 4 is a diagram showing information that is stored on a user management database 103. The user management database 103 associates and stores a card ID 701, a username 702, a password 703, a user classification 704, a usage period 705, a UUID 706, and a device hash 707.

The card ID 701 shows identification information for an IC card that is stored on an IC card that is owned by the user. In the present embodiment, different identification information for each IC card is stored on IC cards, and the card ID 701 shows identification information for each IC card. Therefore, the card ID 701 can also be perceived as information that identifies a user.

The username 702 shows information that identifies a user.

The password 703 shows a password that is used for user authentication in a case in which the user is logging in to the remote UI via the information terminal 101. In the present embodiment, the username 702 and the password 703 are used in user authentication for logging the user in to the remote UI.

The user classification 704 shows a classification of the user for which the authority for use of the functions that can be provided by the multifunction peripheral 102 is different. In the example shown in the figures, the user classification 704 shows one of “manager”, “general”, and “guest”. In the present embodiment, the functions that a user is able to use by using the information terminal 101 from among the functions that are provided from the multifunction peripheral 102 are determined according to the user classification that is shown in the user classification 704. For example, changes to the network settings for the multifunction peripheral 102, user management such the addition, deletion, and the like of users that are able to use the multifunction peripheral 102, and the like are given as examples of the authority that is conferred to the users for which “manager” is shown in the user classification 704. For example, transmitting commands for jobs such as printing, scanning, copying, and the like to the multifunction peripheral 102 is given as an example of the authority that is conferred to users for which “general” is shown in the user classification 704. In addition, the contents that were explained above as the authority that is conferred to a “manager” user is given as an example of authority that is not conferred to a “general” user. In addition, transmitting print commands to the multifunction peripheral 102 is given as an example of the authority that is conferred to users for which “guest” is shown in the user classification 704. In addition, the functions other than transmitting print commands to the multifunction peripheral 102 from among each of the functions that it is possible for the multifunction peripheral 102 to provide to the information terminal 101 are given as examples of the authority that is not conferred to a “guest” user.

The usage period 705 displays the usage period of the password 703.

The UUID 706 displays a UUID (Universally Unique Identifier) that has been associated with the username 702.

The device hash 707 shows information that identifies the multifunction peripheral 102.

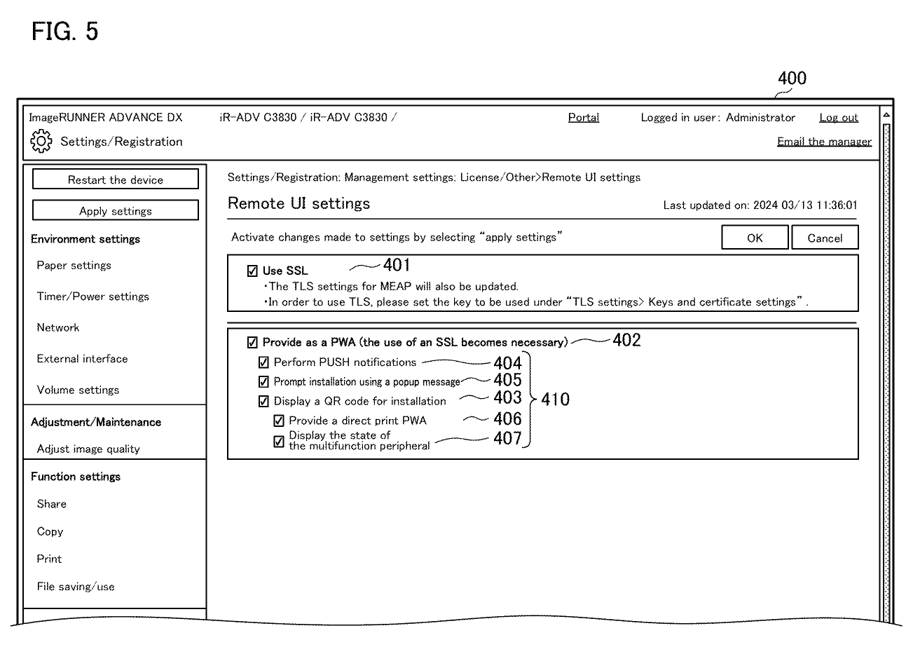

FIG. 5 is a diagram showing a setting screen 400. The setting screen 400 is a screen that receives settings from a manger with respect to the usage of the PWA by the user. Note that the manager is a person who manages the function provision system 1. In addition, the setting screen 400 is displayed on a manager terminal (not shown), which is a terminal that is used by the manager, However, the setting screen 400 may also be displayed on the multifunction peripheral 102. The control unit 308 of the multifunction peripheral 102 displays the setting screen 400 according to operations to the multifunction peripheral or the manager terminal of the manager.

The setting screen 400 displays an SSL receiving unit 401, a PWA receiving unit 402, and a function receiving unit 410.

The SSL receiving unit 401 receives communications from the information terminal 101 and the multifunction peripheral 102 using an SSL (secure sockets layer). When the manager selects the SSL receiving unit 401, settings are performed by the control unit 308 of the multifunction peripheral 102 in order to activate the SSL. The text “Use SSL” is displayed on the SSL receiving unit 402.

In the present embodiment, the usage of the PWA by the information terminal 101, in other words, the provision of a remote UI to the information terminal 101 from the multifunction peripheral 102, is performed with the condition that the information terminal 101 and the multifunction peripheral 102 perform communications using the SSL.

The PWA receiving unit 402 receives permission from the manager to install the PWA on the information terminal 101. Although a detailed explanation will be given below, in a case in which the PWA receiving unit 402 is selected by the manager, the information showing the address for the installation website is displayed on the display unit 306 of the multifunction peripheral 102. The text “Provide as a PWA” is shown on the PWA receiving unit 402. In addition, information is also shown on the PWA receiving unit 402 showing that the provision of the remote UI to the information terminal 101 from the multifunction peripheral 102 is performed with the condition that communication with the information terminal 101 and the multifunction peripheral 102 is performed using SSL. More specifically, the text “Use of an SSL is necessary” is shown on the PWA receiving unit 402.

The function receiving unit 410 receives the selection from the manager of a function to be provided to the information terminal 101 in relation to the use of the PWA by the information terminal 101. The function receiving unit 410 shows a notification receiving unit 404, a prompt receiving unit 405, a code receiving unit 403, a job receiving unit 406, and a state receiving unit 407.

The notification receiving unit 404 receives the selection from the manager of the provision of a push notification function to the information terminal 101. When the manager selects the notification receiving unit 404, a function in which the multifunction peripheral 102 provides push notifications to the information terminal 101 is provided to the information terminal 101.

The prompt receiving unit 405 receives a prompt from the information terminal 101 to the user to install the PWA. In a case in which the prompt receiving unit 405 is selected by the manager, a PoP (Post Office Protocol) message for prompting the user to install the PWA is displayed on the information terminal 101 by the information terminal 101.

The code receiving unit 403 receives the selection from the manager of a function that displays code information in which the address information for the installation website has been encoded on the multifunction peripheral 102. In a case in which the code receiving unit is selected by the manager, the code information in which the address information for the installation website has been encoded is displayed on the display unit 306 of the multifunction peripheral 102. In the example in the figures, the code receiving unit 403 shows the text “display QR code for installation”, which means that a QR code will be displayed as the code information.

The job receiving unit 406 receives the selection from the manager of a function in which it becomes possible for the information terminal 101 to send job commands to the multifunction peripheral 102. When the manager selects the job receiving unit 406, it becomes possible for the information terminal 101 to send job commands to the multifunction peripheral 102. In the example in the figures, the text “provide a direct print PWA” is shown on the job receiving unit 406, which means that it will become possible for the information terminal 101 to send print job commands to the multifunction peripheral 102.

The state receiving unit 407 receives the selection from the manager of a function that displays information showing the state of the multifunction peripheral 102 on the information terminal 101. In a case in which the manager selects the state receiving unit 407, information showing the state of the multifunction peripheral 102 is displayed on the output apparatus 206 of the information terminal 101.

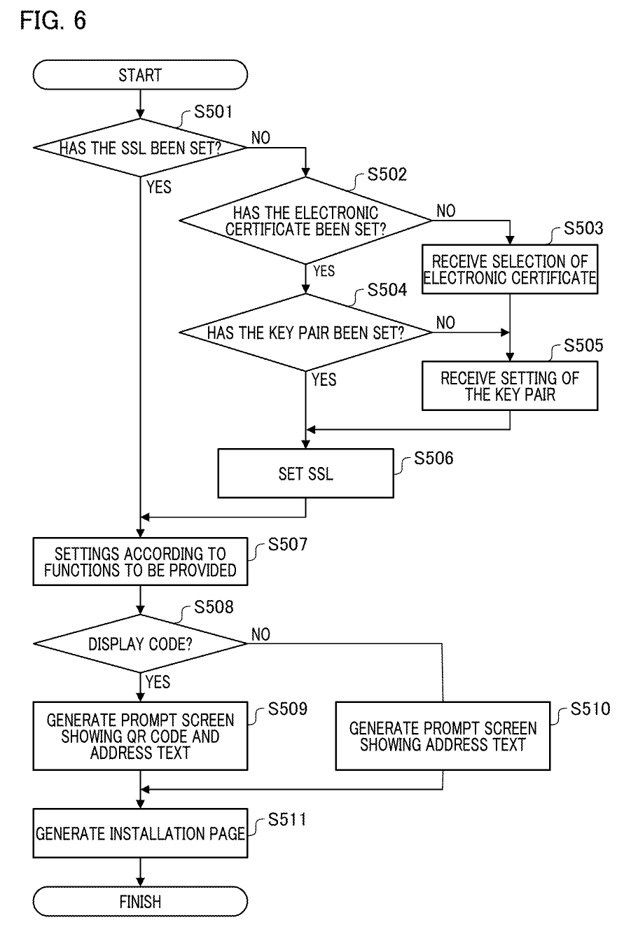

FIG. 6 is a flowchart showing the flow for generation processing. Generation processing is processing in which the control unit 308 of the multifunction peripheral 102 generates information relating to the PWA. In the present embodiment, when the PWA receiving unit 402 is selected on the setting screen 400 (refer to FIG. 5), generation processing begins.

The control unit 308 determines whether or not SSL settings have been completed for the communications for the information terminal 101 and the multifunction peripheral 102 (Step 501 (below, there are cases in which step will be notated as “S”)). The control unit 308 performs the determination for step 501 according to whether or not the SSL receiving unit 401 on the settings screen 400 has been selected.

In a case in which the SSL settings have not been completed (no during S501), the control unit 308 determines whether or not settings have been completed for an electronic certificate that is used in SSL communications (S502).

In a case in which settings have not been completed for an electronic certificate (no during S502), the control unit 308 receives the selection by the manager of an electronic certificate that is used in SSL communications from electronic certificates that have already been installed on the multifunction peripheral 102 (S503). The selection of the electronic certificate that is used during SSL communications is received from the manager (S503). The control unit 308 receives the selection from the manager by displaying, on the multifunction peripheral 102 and the manager terminal, a list of the electronic certificates that have already been installed. Note that a pair of a public key and private key that are used in SSL communications are acquired by the multifunction peripheral 102 through the selection of the electronic certificate to be used in the SSL communications.

In addition, in a case in which settings for the an electronic certificate have been completed (yes during S502), the control unit 308 determines whether or not settings have been completed for the pair of a public key and a private key that will be used in SSL communications (S504).

In a case in which settings have not been completed for the pair of keys (no during S504), and in addition, after step S503, the control unit 308 receives the selection from the manager of the pair of keys to be used during SSL communications (S505). The control unit 308 receives the selection from the manger by displaying, on the multifunction peripheral and the management terminal, a list of pairs of keys that have already been acquired.

In a case in which the settings have been completed for the pair of keys (yes during S504), and in addition, after step S505, the control unit 308 sets the SLL that is used in communications with the information terminal 101 and the multifunction peripheral 102 to be activated (S506).

The control unit 308 performs settings according to the function that has been selected in the function receiving unit 410 of the settings screen 400 as the function to be provided to the information terminal 101 by the use of the PWA by the information terminal 101 (S507). For example, in a case in which the prompt receiving unit 405 has been selected on the settings screen 400, the control unit 308 generates a PoP message for promoting the user to install the PWA for the information terminal 101. In addition, for example, in a case in which the notification receiving unit 404 has been selected on the settings screen 400, the control unit 308 sets information necessary for push notifications in the settings file for the Service Worker. The service worker is a script that is executed in the background separately from the webpage by the browser of the information terminal 101 in order to realize the functions of push notifications, background synchronization, and the like for the PWA. In this manner, during step S507, the control unit 308 generates information for providing the function that has been selected on the settings screen 410 to the information terminal 101, and the information that has been generated is disposed in a predetermined location of the webserver 305.

Next, the control unit 308 determines whether or not to display the information showing the address for the installation website as code information (S508). The control unit 308 performs the determination for step S508 according to whether or not the code receiving unit 403 has been selected on the settings screen 400.

In a case in which the control unit 308 will display code information (yes during S508), a prompting screen on which a QR code in which information showing the address for the installation website has been encoded, and text information showing the address for the installation website are shown is generated (S509). A detailed explanation of the prompting screen will be given below.

In addition, in a case in which the control unit 308 will not display code information (no during S508), a prompting screen on which text information for showing the address of the installation website is shown is generated (S510), The prompting screen that is generated at this time does not display a QR code.

The control unit 308 generates a webpage for the information terminal 101 to install the PWA, and disposes the webpage that has been generated in a predetermined location in the webserver 305 (S511)

Note that in a case in which the SSL receiving unit 401 of the settings screen 400 (refer to FIG. 5) has been selected, the SLL that is used in communications with the information terminal 101 and the multifunction peripheral 102 is set to be activated by the processing for step S502 through step S506 in the generation processing being performed. In addition, the control unit 308 can also be understood as a setting unit that performs settings for electronic keys used in encoding and decoding communication contents, and settings for an electronic certificate of the webserver 305.

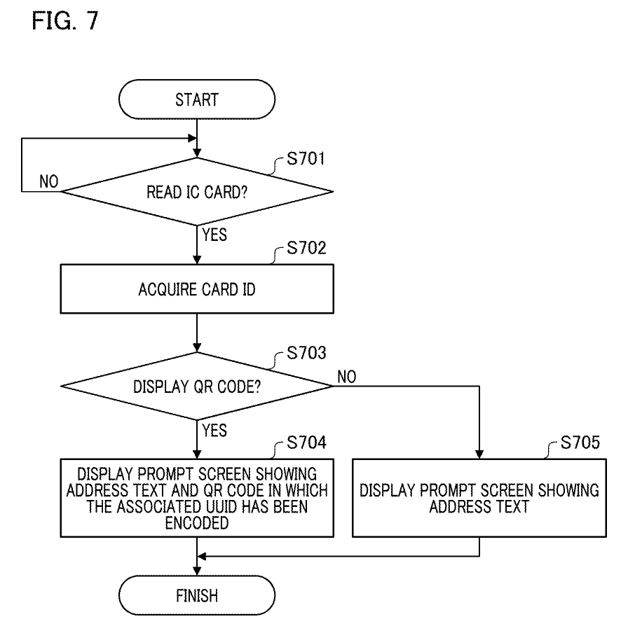

FIG. 7 is a flowchart showing the flow for display processing. The display processing is processing in which the control unit 308 of the multifunction peripheral displays the prompting screen. In the present embodiment, when the generation processing (refer to FIG. 6) is completed, the display processing begins.

The control unit 308 determines whether or not the IC card that was described above has been read by the card reader 241 of the multifunction peripheral 102 (S701). During step S701, while negative determination results continue (no during step S701), the processing for step S701 is repeated.

In addition, in a case in which the IC card has been read by the card reader 241 of the multifunction peripheral 102 (yes during S701), the control unit 308 acquires the card ID that is stored on the IC card that has been read via the transmitting and receiving unit 304 (S702).

The control unit 308 determines whether or not to display a QR code on the prompting screen (S703). The control unit 308 performs the determination for step S703 according to whether or not the processing for step 509 has been performed during the generation processing, and whether or not the processing for step 510 has been performed during the generation processing.

In a case in which the control unit 308 will display a QR code on the prompting screen (yes during S703), the control unit 308 references information such as the card ID 701 that is stored on the user management database 103, and the like (refer to FIG. 4). In addition, the control unit 308 displays a prompting screen on which a QR code in which the UUID 706 that is associated with the card ID 701 that has been acquired during step 702 has been encoded, and text information showing the address for the installation website have been displayed (S704).

In addition, in a case in which the control unit 308 will not display a QR code on the prompting screen (no during S703), the control unit 308 displays a prompting screen on which text information showing the address for the installation site has been displayed (S705). The prompting screen that is displayed at this time does not display a QR code.

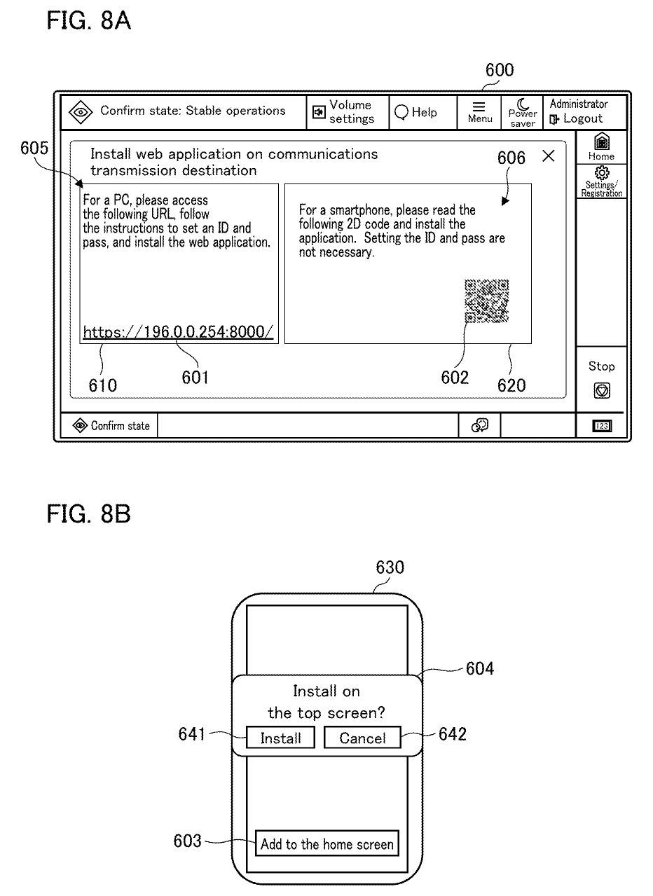

FIG. 8A is a diagram showing a prompting screen 600. The prompting screen 600 is a screen for prompting the user to install the PWA on the information terminal 101. After the execution of the generation processing (refer to FIG. 6), in a case in which the IC card has been read by the card reader 241 of the multifunction peripheral 102, the prompting screen 600 is displayed (refer to step 704, and step 705 of FIG. 7). In addition, the prompting screen 600 is displayed on the display unit 306 of the multifunction peripheral 102. Note that the prompting screen 600 that is shown in FIG. 8 is displayed on the display unit 306 of the multifunction peripheral 102. Note that the prompting screen 600 that is shown in FIG. 8 is a prompting screen 600 that is displayed in a case in which the generation processing (refer to FIG. 6) was performed in a state in which the code receiving unit 403 had been selected on the settings screen 400.

A text prompting image 610, and a code prompting image 620 are displayed on the prompting screen 600.

The text prompting image 610 prompts the installation of the PWA on the information terminal 101 by inputting the address of the installation website into the information terminal 101 as characters. A text prompting unit 605 and an address unit 601 are displayed on the text prompting unit 605.

The text prompting unit 605 displays information that prompts the installation of the PWA onto the information terminal 101 by inputting the address for the installation website into the information terminal 101 as characters. In the example in the figures, the text prompting unit 605 displays the text “For a PC, please access the following URL, follow the instructions to set an ID and Pass, and install the web application.”.

The address unit 601 shows the URL, which is the address for the installation website as characters.

The code prompting screen 620 prompts the installation of the PWA on the information terminal 101 by having the information terminal 101 read a QR code in which the address of the installation website has been encoded. The code prompting screen 620 displays a QR code unit 602, and a code prompting unit 606.

The QR code unit 602 shows a QR code in which the address for the installation website has been encoded. The address that is shown by the QR code unit 602 as encoded information is a local IP address that has been set when connecting to a LAN at the time of installation or after the installation of the multifunction peripheral 102, and an address that is configured by a host name and HTML contents to be provided. In addition, as was explained above, the QR code that has been displayed on the QR code unit 602 is a QR code including information in which the UUID (refer to FIG. 4) that has been associated with the card ID for the IC card that has been read by the card reader 241 has been encoded. That is, the QR code unit 602 displays a QR code according to the IC card that has been read by the card reader 241.

Note that information showing the UUID is not included in the address unit 601.

The code prompting unit 606 displays information that prompts the installation of the PWA by the information terminal 101 by having the information terminal 101 read the QR code in which the address for the installation website has been encoded. In the example in the figures, the code prompting unit 606 shows the text “When using a smartphone, please read the 2D code shown below, and perform installation.”. In addition, in a case in which the information terminal 110 will read the QR code that has been shown in the QR code unit 602, and install the PWA, the code prompting unit 606 shows information that means that settings relating to user authentication necessary for using the PWA are unnecessary. In the example in the figures, the text “It is not necessary to set the ID/Pass.” is displayed on the code prompting unit 606.

Note that as has been explained above, if on the settings screen 400 (refer to FIG. 5), the PWA receiving unit 402 is selected without the code receiving unit 403 having been selected, the processing for step S510 is performed during the generation processing (refer to FIG. 6), and the processing for step S705 is performed during the display processing (refer to FIG. 7). In this case, the prompting screen 600 that is shown on the display unit 306 does not display the code prompting screen 620.

In this context, for example, the user operates the information terminal 101, inputs the URL that has been shown on the address unit 601 into the information terminal 101, or makes the information terminal 101 read the QR code that has been displayed on the QR code unit 602. In this case, as is shown in FIG. 8B, the installation screen 630, which is the installation website, is displayed on the output apparatus 206 of the information terminal 101. The installation screen 630, which is one example of an installation page, is a screen that is used in the installation of the PWA by the information terminal 101.

Note that in a case in which the QR code from the QR code unit 602 is read by the information terminal 101, a request is made to the webserver 305 of the multifunction peripheral 102 to acquire the web contents that are displayed on the browser 310 by starting up the browser 310 of the information terminal 101, The webserver 305 acquires the web contents that have been requested, and transmits the web contents to the browser 310 of the information terminal 101. The browser 310 displays the page for the URL on which the web contents that have been acquired were decoded and read by the information processing unit 311 on the output apparatus 206 as an installation screen 630. In this context, the web contents include UI information and PWA information. The UI information is configured by, for example, HTML, Java Script, CSS, and the like. The PWA information includes a Service Worker, and a manifest file (a file that discloses the installation settings for the PWA), which are configurational elements of the PWA.

The installation receiving unit 603 is displayed on the installation screen 603. When the installation receiving unit 603 is selected by the user, the installation of the PWA is executed by the information terminal 101.

In addition, in a case in which the prompt receiving unit 405 is selected on the settings screen 400, the installation prompting screen 604 is displayed on the output apparatus of the information terminal 101. An installation receiving unit 641 that receives the installation of the PWA by the information terminal 101, and a cancel receiving unit 642 that receives the cancelation of the installation of the PWA by the information terminal 101 is shown on the installation prompting screen 604. Therefore, the installation prompt screen 604, which is one example of an installation webpage, can also be understood as an installation website.

During the installation of the PWA by the information terminal 101, the service worker is registered on the browser 310. There are specifications in the standards for the PWA for the service worker, and the service worker is a program (JavaScript) for which the operations such as the push notification function, operations when online, display of icons on the home screen, and the like, which are also the features of the PWA, are defined. The service worker is executed in the background separately from the display of the browser 310. In addition, in a case in which the notification receiving unit 404 has been selected on the setting screen 400, the information terminal 101 requests registration for push notifications to the push server 104. The push server 104 registers the information terminal 101 for which there has been a request as a target for push notifications. In addition, when the server worker is registered on the browser 310, the browser 310 notifies the control unit 308 of the registration results. In this case, when a state that requires notification has occurred in the multifunction peripheral 102, the control unit 308 requests the generation of a push notification from the push server 104 by specifying a web API key that shows the information terminal 101, which is the transmission destination, a contents URL as notification contents, and the like, and. That is, the control unit 308 functions as a web application server. In addition, the push server 104 performs push notifications by transmitting the contents that have been requested to the information terminal 101.

In addition, after the information terminal 101 has installed the PWA, the PWA is added as a desk top icon according to the screen design of the OS for the information device 101, and therefore, the top page for the remote UI is displayed on the output apparatus 206 by the user selecting the icon. The use of the remote UI by the user thereby begins without the user being aware of the browser 310.

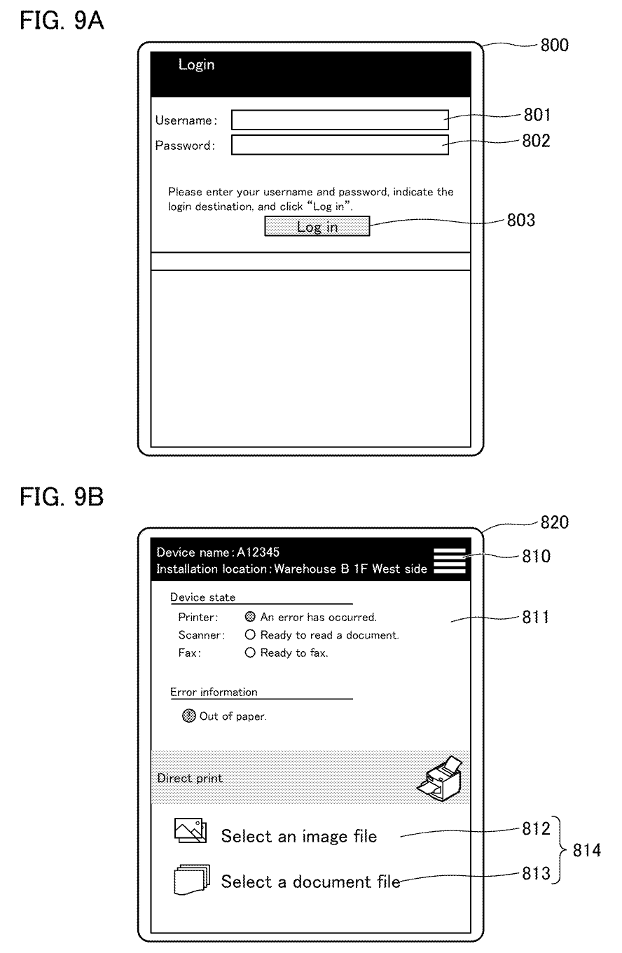

FIG. 9A is a diagram showing an authentication screen 800. The authentication screen 800 is a screen for authenticating the user in a case in which the information terminal 101 will use the PWA. In the present embodiment, in a case in which the PWA has been installed on the information terminal 101, and in a case in which the user commands the information terminal 101 to use the PWA, the authentication screen 800 is displayed. A username receiving unit 801, a password receiving unit 802, and a verification receiving unit 803 are displayed on the authentication screen 800.

The username receiving unit 801 receives an input of a username.

The password receiving unit 802 receives an input of a password.

The verification receiving unit 803 receives a verification command for the information that has been input into the username receiving unit 801 and the password receiving unit 802. Upon selecting the verification receiving unit 803, the information terminal 101 transmits the username that was input into the username receiving unit 801, and the password that was input into the password receiving unit 802 to the multifunction peripheral 102. In a case in which the username and password that have been transmitted from the information terminal 101 and received by the transmitting and receiving unit 304 match the username 702 and the password 703 that have been stored in the user management database 103 for this user, the control unit 308 authenticates the user. In addition, in a case in which the control unit 308 authenticates the user, the provision screen 820 shown in FIG. 9B is displayed on the output apparatus 206 of the information terminal 101. Therefore, the username and password can also be understood as authentication information for authenticating a user. In addition, the authentication information can also be understood as information for authenticating the information terminal 101.

The provision screen 820 is a screen that shows information that is provided to the information terminal 101 as a portion of the functions of the multifunction peripheral 102 by the use of the PWA by the informational terminal 101. A menu unit 810, a state image 811, and a job image 814 are displayed on the provision screen 820.

The menu unit 810 receives a selection of the functions that the user would like to use.

A state of the printer function, a state of the scanner function, and a state of the fax function are displayed on the state screen 811 as states for each function of the multifunction peripheral 102. More specifically, it is displayed on the state screen 811 that an error is occurring in the printer, that reading using the scanner is possible, and that faxing is possible. In addition, the state screen 811 displays the text “error information” and “out of paper”, which mean that the contents of the error that has occurred in the printer is that the printer has run out of paper.

The job screen 814 receives the selection of contents for a job for which a command has been sent to the multifunction peripheral. In the example in the figures, the job screen 814 receives the selection of the contents for printing for which the multifunction peripheral has received a command. An image receiving unit 812 that receives the selection of an image file to be printed by the multifunction peripheral 102, and a document receiving unit 813 that receives the selection of a document file to be printed by the multifunction peripheral 102 are shown on the job screen 814. The user selects the image receiving unit 812 and the document receiving unit 813, and after indicating the file that is the target of the printing, sends a print command to the information terminal 101. In this case, the information terminal 101 transmits the print command and the file that has been indicated to the multifunction peripheral 102. The control unit 308 of the multifunction peripheral 102 processes the file that has been transmitted from the information terminal 101. The file that has been processed is printed by the print engine 238 via the raster controller 237.

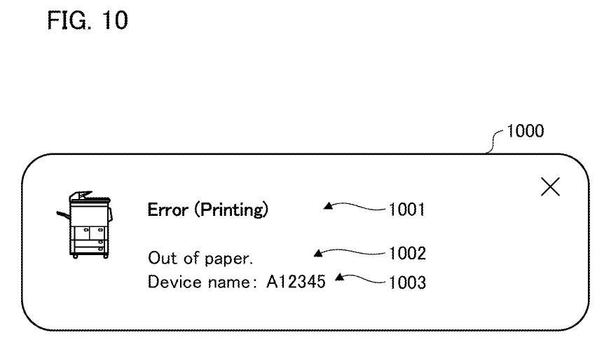

FIG. 10 is a diagram showing a notification image 1000. The notification image 1000 is an image showing contents of which the information terminal 101 will be notified in a push notification that the multifunction peripheral 102 performs to the information terminal 101. In the present embodiment, in a case in which a change occurs to a state that has been determined in advance in the multifunction peripheral 102, a push notification is performed by the notification image 1000 being displayed on the output apparatus 206 of the information terminal 101.

A classification notification unit 1001, a contents notification unit 1002, and a device notification unit 1003 are shown on the notification image 1000.

The classification notification unit 1001 shows the text “an error has occurred”, which is the classification of the change that has occurred in the state of the multifunction peripheral 102, and the text “printing”, which is the classification of the function for which the state has changed.

The contents of the change in the state of the multifunction peripheral 102 are shown in the contents notification unit 1002. In the example in the figures, the text “there is no paper” is shown in the contents notification unit 1002.

Information identifying the multifunction peripheral 102 for which a change in state has occurred is shown in the device notification unit 1003.

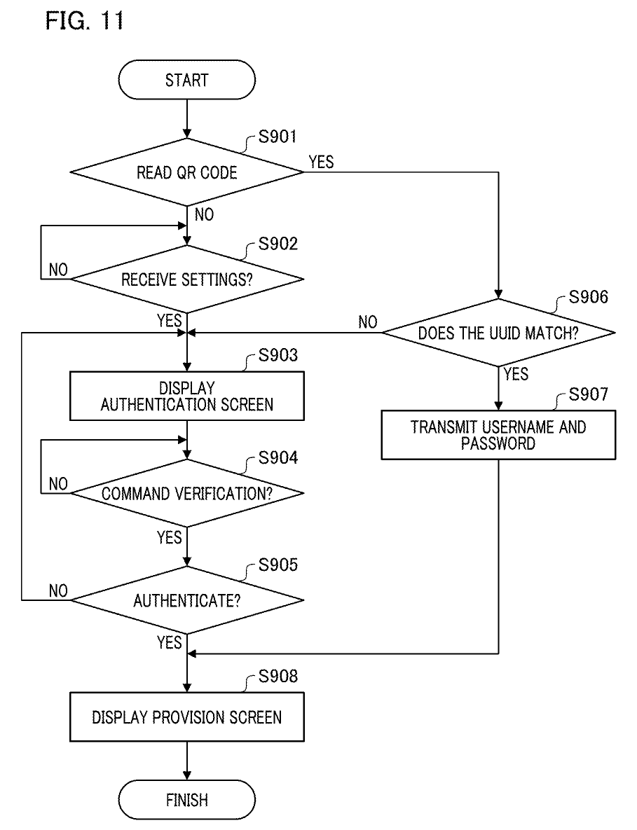

FIG. 11 is a flowchart showing a flow for provision processing. The provision processing is processing in which the control unit 308 of the multifunction peripheral 102 displays the provision screen 820 (refer to FIG. 9B) on the information terminal 101. In the present embodiment, when the information terminal 101 installs the PWA, the provision processing begins.

The control unit 308 determines whether or not the installation of the PWA by the information terminal 101 has been performed via the information terminal 101 reading the QR code that was displayed on the QR code unit 602 (S901). In a case in which the QR code that was displayed by the QR code unit 602 of the prompt screen 600 has been read, the information terminal 101 transmits the UUID that was included in the QR code as encoded information to the multifunction peripheral 102 when requesting the acquisition of web contents from the multifunction peripheral 102. Therefore, in a case in which the UUID has been transmitted from the information terminal 101, the control unit 308 determines that the installation has been performed by the information terminal 101 having read the QR code. In addition, in a case in which the address information that was shown in the address unit 601 of the prompt screen 600 has been input into the information terminal 101, the information terminal 101 requests the acquisition of the web contents from the multifunction peripheral 102 but does not transmit the UUID. Therefore, in a case in which the UUID has not been transmitted from the information terminal 101, the control unit 308 determines that the installation has not been performed by the information terminal 101 reading the QR code.

In a case in which the QR code has not been read (No during S901), the control unit 308 displays, on the information terminal 101, a screen (not shown) for setting the username and password that are used to authenticate the user, and determines whether or not these settings have been received (S902). While negative determination results continue during step S902 (no during S902), the processing for step S902 is repeated.

When the settings for the username and password are received (yes during S902), the control unit 308 displays the authentication screen 800 (refer to FIG. 9A) on the information terminal 101 (S903).

The control unit 308 determines whether or not there has been a command to verify the authentication information (S904). The control unit 803 performs the determination for step 904 according to whether or not the verification receiving unit 803 has been selected on the authentication screen 800. In addition, while negative determination results continue during step S904 (no during S904), the processing for step S904 is repeated.

In a case in which the verification of the authentication information has been commanded (yes during S904), the control unit 308 determines whether or not to authenticate the user (S905). The control unit 308 performs the determination for step S905 according to whether or not the username and password that have been input into the authentication screen 800 match the username 702 and the password 703 that have been stored on the user management database 103. In addition, in a case in which at least one of the username and password that have been input into the authentication screen 800 are different from the username 702 and the password 703 that are stored in the user management database 103 (no during S905), the processing from step S903 onward is repeated.

In addition, in a case in which the QR code has been read (yes during S901), the control unit 308 determines whether or not the UUID that has been acquired from the information terminal 101 matches the UUID 706 that is stored in the user management database 103 (S906). The control unit 308 extracts the UUID 706 that has been associated with the card ID 701 that has been stored on the IC card that was read by the card reader 241 from among the UUIDs 706 that are stored in the user management database 103. In addition, the control unit 308 performs the determination for step S906 according to whether or not the UUID 706 that has been extracted matches the UUID that was acquired from the information terminal 101.

In a case in which the UUID that has been transmitted from the information terminal 101 does not match the UUID 706 that is stored on the user management database 103 (no during S906), the processing from step S903 onward is performed.

In a case in which the UUID that has been transmitted from the information terminal 101 matches the UUID 706 that is stored in the user management database 103 (yes during S906), the processing proceeds to the next step. The control unit 308 transmits the username 702 and the password 703 that are associated in the user management database 103 with the UUID 706 that was used during this verification to the information terminal 101. That is, in a case in which the information terminal 101 installs the PWA by reading the QR code that has been displayed on the QR code unit 602, the user is authenticated without settings for the authentication information and the input of the authentication information being performed by the user. Therefore, the UUID can also be understood as authentication information for authenticating a user. In addition, the information terminal 101 stores the username 702 and the password 703 that have been acquired on the storage 313.

In addition, in a case in which the user has been authenticated (yes during S905), or after step S907, the control unit 308 displays the provision screen 820 on the information terminal 101 (S908). Note that in a case in which the user has been authenticated, the username 702 and the password 703 are stored in the storage 313 of the information terminal 101 as authentication information that was used in the authentication.

In addition, in a case in which the username 702 and the password 703 are stored in the storage 313, when the authentication screen 800 is displayed, the information terminal 101 inputs the username 702 and the password 703 that are stored into the authentication screen 800 that has been displayed. Therefore, after the username 702 and the password 703 have been stored on the storage 313, there is no need for the user to input the authentication information into the authentication screen 800.

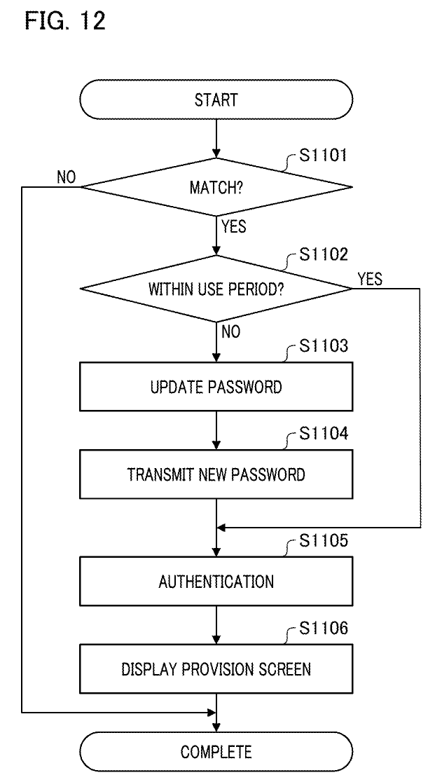

FIG. 12 is a flowchart showing the flow of the update processing. The update processing is processing in which the control unit 308 of the multifunction peripheral 102 updates the authentication information in a case in which the usage period for the authentication information has elapsed. In the present embodiment, when the verification receiving unit 803 is selected on the authentication screen 800 (refer to FIG. 9A), the update processing beings.

The control unit 308 determines whether or not the username and password that have been input into the authentication screen 800 match the username 702 and the password 703 that are stored on the user management database 103 (S11011).

In a case in which the authentication information that has been input into the authentication screen 800 does not match the authentication information that is stored in the user management database 103 (no during S1101), the update processing is completed. In this case, the user is prompted to input the authentication information into the authentication screen 800 again.

In addition, in a case in which the authentication information that has been input into the authentication screen 800 does match the authentication information that is stored on the user management database 103 (yes during S1011), the processing proceeds to the next step. The control unit 308 determines whether or not the password 703 that was used in the authentication is within the period in which it can be used (S1102). The control unit 308 performs the determination for step S1002 according to whether or not the current date is before a date that has been displayed in the usage period 705 that is associated with the password that was used in the authentication in the user management database 103.

In a case in which the usage period for the password 703 has elapsed (no during S1102), the control unit 308 updates the password 703 by generating a new password 703 (S1103). More specifically, the control unit 308 overwrites the password 703 for which the period has expired that is stored in the user management database 103 with the password 703 that has been newly generated. Furthermore, the control unit 308 newly sets the usage period 705 for the new password 703.

The control unit 308 transmits the newly generated password 703 to the information terminal 101 (S104). In this case, the password 703 for which the usage period has elapsed is overwritten in the storage 313 of the information terminal 101 with the newly generated password 703.

In a case in which the usage period for the password 703 has not elapsed (yes during S1102), or after step S1104, the control unit 308 authenticates the user (S1105), and displays the provision screen 820 on the information terminal 101 (S1106). That is, in a case in which the authentication information that has been input into the authentication screen 800 matches the authentication information that is stored on the user management database 103, even in a case in which the usage period for the password 703 has elapsed, the user is authenticated without requiring any further operations from the user. More specifically, the user is authenticated without the user needing to generate a new password and input the password again.

As has been explained above, in the present embodiment, there is a website that is provided by the webserver 305 for installing software that functions as a PWA for providing at least a portion of the functions of the multifunction peripheral 102 on the information terminal 101. In addition, the control unit 308 of the multifunction peripheral 102 displays code information for accessing this website using the browser 310 on the display unit 306. For example, the installation screen 630, which is the installation website, and the like, is given as an example of the website.

In this case, the user is able to install the PWA on the information terminal 101 without inputting the address of the installation site into the information terminal 101 by reading the code information with the information terminal 101. Therefore, in a state in which the user is able to operate the multifunction peripheral 102, it is possible for the user to easily execute the installation of the PWA for providing at least a portion of the functions of the multifunction peripheral 102 on the information terminal 101.

In addition, the code information is a QR code in which information showing the address of the website has been encoded.

In this case, the user does not need to newly perform settings for reading the code information in order to install the PWA on the information terminal 101, which is able to read the QR code.

In addition, the control unit 308 displays the setting screen 400, which receives settings by the manger relating to the use of the software as the PWA. In addition, the provision of at least a portion of the functions of the multifunction peripheral 102 by the software as the PWA is performed with the condition that the communications with the information terminal 101 and the multifunction peripheral 102 are encoded. In addition, a receiving image for receiving the settings for the encoding of the communications is displayed on the setting screen 400. An SSL receiving unit 402, a PWA receiving unit 402, and the like are given as examples of the receiving image. In addition, in a case in which settings for encryption have been received on the receiving image, the control unit 308 performs settings for electronic keys that are used in encoding and decoding the contents of the communications, and settings for an electronic certificate for the webserver 305. A public key and a private key are given as an example of the electronic keys that are used in encoding and decoding the contents of the communications.

In this case, the manager does not need to perform the settings relating to the use of the PWA and the settings for the encoding of the communications on different screens.

In addition, the control unit 308 displays information on the settings screen 400 that encoding of communications is made a condition for the provision of at least a portion of the functions of the multifunction peripheral 102 by the software as the PWA (Refer to the PWA receiving unit of FIG. 5).

In this case, it is possible for the manager to set the encoding of communications after having recognized that that the encoding of communications is a condition of use for the PWA.

In addition, at the least, push notifications of information showing the contents of changes that have occurred with respect to the state of the multifunction peripheral 102 are included in the functions of the multifunction peripheral 102 that are provided by the software as the PWA (refer to FIG. 10).

In this case, it is possible for the user to recognize changes in the state of the multifunction peripheral 102 without the user needing to operate the multifunction peripheral 102.

In addition, the control unit 308 displays an authentication screen 800 on the information terminal 101 in order to authenticate the information terminal 101 on which the software as the PWA has been installed. In addition, in a case in which the input information that has been input onto the authentication screen 800 matches information that has been determined in advance, the control unit 308 authenticates the information terminal 101. The information that has been input into the username receiving unit 801, and the information that has been input into the password receiving unit 802, and the like are given as examples of the input information. In addition, the username 702, the password 703, and the like are given as examples of the information that has been determined in advance. In addition, information in which authentication information for authenticating the information terminal 101 has been encoded is included in the code information, A UUID is given as an example of the authentication information.

In this case, the burden according to the authentication of the user of the information terminal 101 for which the code information has been read is reduced.

In addition, the control unit 308 also displays specific character information that shows the address of the website, and code information on the display unit 306. The address unit 601 is given as an example of the specific character information. In addition, the specific character information does not include authentication information.

In this case, cases in which a person who is different from the user of the information terminal 101 for which the code information has been read uses the information for the address unit 601 and uses the PWA instead of the user of the information terminal for which the code information has been read are suppressed.

In addition, the transmitting and receiving unit 304 of the multifunction peripheral 102 acquires identification information that identifies the user and authentication information. The card ID 701 is given as an example of the identification information. In addition, the identification information is associated with the authentication information (refer to FIG. 4). In addition, the control unit 308 displays code information including information in which the authentication information that has been associated with the identification information that has been acquired by the transmitting and receiving unit 304 has been encoded on the display unit 306. In addition, upon the authentication information being acquired by the transmitting and receiving unit 304, the control unit 308 provides, to the information terminal 101, the functions according to the user that is specified by the authentication information that has been acquired from among the functions of the multifunction peripheral 102, through the use of the software as the PWA by the information terminal 101. Functions according to the user classification 704 that has been associated with the UUID that was acquired by the transmitting and receiving unit 304 in the user management database 103 are given as an example of the functions according to the user that are specified by the authentication information that has been acquired.

In this case, even in a case in which the functions that are provided to the information terminal 101 by the use of the PWA by the information terminal 101 differ based on the user, the burden according to authenticating the user of the information terminal 101 for which the code has been read is reduced.

Note that although in the present embodiment, usage restrictions are set in the password 703, the present disclosure is not limited thereto. Usage restrictions for the password 703 do not need to be provided.

In addition, although in the present embodiment, an explanation has been given in which information in which the UUID has been encoded is included in the code information, the present disclosure is not limited thereto. Information in which the username 702 and the password 703, and the like have been encoded instead of the UUID may also be included in the code information. However, in comparison to a case in which information in which the username 702 and the password 703, and the like have been encoded is included in the code information, greater privacy protection is planned in a case in which the information that is included in the code information is information in which the UUID has been encoded.

In addition, although in the present embodiment, an explanation has been given in which the functions that are provided to the information terminal 101 from the multifunction peripheral 102 via the use of the PWA by the information terminal 101 differ according to the user, the present disclosure is not limited thereto. The functions that are provided to the information terminal 101 from the multifunction peripheral 102 via the use of the PWA by the information terminal 101 may also be the same regardless of the user.

In addition, although in the present embodiment, an example has been explained in which the card ID 701, the username 702, the password 703, and the UUID 706 are different for each user, the present disclosure is not limited thereto. The card ID 701, the username 702, the password 703, and the UUID 706 may also be the same regardless of the user. However, an increase in security is planned due to the prevention of multi-use of code information in a case in which the card ID 701, the username 702, the password 703, and the UUID 706 are different for each user.

In addition, although in the present embodiment, an explanation has been given in which the use of the PWA by the information terminal 101 is approved via the authentication of the user by the authentication screen 800, the present disclosure is not limited thereto.

The use of the PWA by the information terminal 101 may also be approved without needing to authenticate the user.

In addition, although in the present embodiment, an explanation has been given in which the code information is a QR code, the present disclosure is not limited thereto.

The code information may also be a two-dimensional code that is different from a QR code, such as a PDF417, a data matrix, and the like. In addition, the code information may also be a code that is different from a two-dimensional code as long as the code information is information that can be read by the information terminal 101.

In addition, the flow for the display processing (refer to FIG. 7) is not limited to the example that has been explained above. For example, it may also be made such that in a case in which he user commands the display of the prompt screen on the display unit 306 by operating the multifunction peripheral 102 after the IC card has been read by the card read 241, the processing for step S703 is begun.

In addition, although in the present embodiment, an example has been given in which the prompt screen 600 is displayed on the multifunction peripheral 102 after the IC card has been read by the card reader 241, the present disclosure is not limited thereto.

The prompt screen 600 may also be displayed on the display unit 306 of the multifunction peripheral 102 regardless of whether or not the IC card is read by the card reader 241 in a case in which the user has commanded the display of the prompt screen on the display unit 306 by operating the multifunction peripheral 102.

In addition, cases in which a software program that realizes the functions of the above-described embodiment is provided to a system or apparatus having a computer that is able to execute this program directly or by using wired/wireless connections from the storage medium, and this program is executed are also included in the present disclosure.

Therefore, the program code itself that is provided to and installed on this computer in order to realize the function processing that was described above with respect to the present disclosure using a computer also realizes the present disclosure. That is, the computer program itself for realizing the function processing of the present disclosure is also included in the present disclosure. In this case, the mode of the program does not matter as long as it has the functions of the program, and may be an object code, a program that is executed by an interpreter, script data that is provided to an OS, and the like. For example, the recording medium for providing the program may also be a magnetic recording medium such as a hard disk, a magnetic tape, and the like, an optical/ magneto-optical recording medium, and a non-volatile semiconductor memory. In addition, as the method for providing the program, a method is also assumed such as a method in which the computer program that forms the present disclosure is recorded on a server on a computer network, and a client computer having a connection downloads and executes the computer program.

In addition, a portion or the entirety of the actual processing may also be performed by an OS and the like that operates on the computer based on commands from the program code, and each function of the embodiment that was described above may be realized by this processing. Furthermore, the program code that has been read from the recording medium may also be written onto a memory that is provided with a function expansion board that has been inserted into the computer and a function expansion unit that has been connected to the computer. In addition, a portion or the entirety of the actual processing may also be performed by a CPU that has been provided with this function expansion board and function expansion unit based on commands from the program code. Even in this case, each function of the embodiment that was described above is realized.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

According to the present disclosure, in a state in which a user is able to operate a network device, it is possible for a user to easily execute the installation of a progressive web app for providing at least one portion of functions of the network device on a user terminal.

This application claims the benefit of Japanese Patent Application No. 2024-154009, filed September 6, 2024, which is hereby incorporated by reference wherein in its entirety.

What is claimed is:

1. A network device having a webserver, the network device comprising:
a display;
at least one memory storing instructions; and
at least one processor executing the stored instructions causing the network device to:
display, on the display, code information for accessing a website on a web browser, the website being provided by the webserver in order to install software as a progressive web app for providing at least a portion of functions of the network device on a user terminal.

2. The network device according to claim 1, wherein the code information is a QR code in which information showing an address for the website has been encoded.

3. The network device according to claim 1, wherein the at least one processor executes the stored instructions further causing the network device to:
display, on the display, a settings screen that receives settings from a manager relating to use of the software as the progressive web app;
provide the at least a portion of the functions of the network device by the software as the progressive web app with a condition that communications between the user terminal and the network device are encoded;
display, on the settings screen, a receiving image that receives settings for encoding of the communications; and
in a case in which the settings for the encoding have been received on the receiving image, perform setting of digital keys that are used in the encoding and decoding of contents of the communications, and setting of an electronic certificate for the webserver.

4. The network device according to claim 3, wherein the at least one processor executes the stored instructions further causing the network device to:
display, on the settings screen, information showing that the at least a portion of the functions of the network device are provided by the software as the progressive web app with the condition that the encoding of the communications is performed.

5. The network device according to claim 1, wherein the functions of the network device that are provided by the software as the progressive web app include at least a push notification for information showing a content of a change that has occurred with respect to a state of the network device.

6. The network device according to claim 1, wherein the at least one processor executes the stored instructions further causing the network device to:
display, on the user terminal, an authentication screen for authenticating the user terminal on which the software as the progressive web app has been installed; and
in a case in which input information that has been input into the authentication screen matches information that has been determined in advance, authenticate the user terminal, wherein
the code information includes information in which authentication information for authenticating the user terminal has been encoded.

7. The network device according to claim 6, wherein the at least one processor executes the stored instructions further causing the network device to:
display, on the display, specific character information showing an address for the website, as well as the code information, and wherein
the specific character information does not include the authentication information.

8. The network device according to claim 6, wherein the at least one processor executes the stored instructions further causing the network device to:
acquire identification information that identifies a user and the authentication information;
associate the identification information with the authentication information;
display, on the display, the code information including information in which the authentication information that has been associated with the identification information that has been acquired has been encoded; and
if the authentication information is acquired, provide to the user terminal, through a use of the software as the progressive web app by the user terminal, functions corresponding to the user, from among the functions of the network device, that are specified from the authentication information that has been acquired.

9. A method for controlling a network device having a webserver, the method comprising:
displaying, on a display of the network device, code information for accessing a website on a web browser, the website being provided by the webserver in order to install software as a progressive web app for providing at least a portion of functions of the network device on a user terminal.

10. A non-transitory storage medium storing a program of a network device having a webserver, causing a computer to perform each step of a method for the network device, the method comprising:
displaying, on a display of the network device, code information for accessing a website on a web browser, the website being provided by the webserver in order to install software as a progressive web app for providing at least a portion of functions of the network device on a user terminal.
